(19) United States
(12) Patent Application Publication
(10) Pub. No.: US 2024/0310554 A1
(43) Pub. Date: Sep. 19, 2024

(54) METHOD FOR METALLOGENIC PREDICTION BY USING MULTI-SOURCE HETEROGENEOUS INFORMATION

(71) Applicants: Tibet Julong Copper Co., Ltd., Lhasa (CN); CHINA UNIVERSITY OF GEOSCIENCES (BEIJING), Beijing (CN)

(72) Inventors: Youye ZHENG, Beijing (CN); Song WU, Beijing (CN); Hongjun CHENG, Beijing (CN); Xiaofang DOU, Beijing (CN); Feng GAO, Beijing (CN); Shucun WANG, Beijing (CN); Defu SHU, Beijing (CN); Jiancuo LUOSANG, Beijing (CN); Jiangang WEI, Beijing (CN); Zhuoga SUOLANG, Beijing (CN)

(73) Assignees: Tibet Julong Copper Co., Ltd., Lhasa (CN); CHINA UNIVERSITY OF GEOSCIENCES (BEIJING), Beijing (CN)

(21) Appl. No.: 18/451,851

(22) Filed: Aug. 18, 2023

(30) Foreign Application Priority Data
Mar. 16, 2023 (CN) 202310271460.7

(51) Int. Cl. G01V 99/00; G06N 3/045; G06N 3/08

(52) U.S. Cl. CPC G01V 20/00; G06N 3/045; G06N 3/08

(57) ABSTRACT

A method for metallogenic prediction by using multi-source heterogeneous information, includes the following steps: collecting geological, geochemical and remote sensing multi-source geoscience information data; building a conceptual model of a metallogenic system; extracting geoscience multi-source spatial proxy mineralization indication information according to the conceptual model of the metallogenic system; integrating and training data based on a neural network to obtain multi-dimensional spatial proxy layer data sets and training points; inputting the multi-dimensional spatial proxy layer data sets and the training points, and applying a machine learning algorithm for hyper-parameter optimization to obtain an optimized machine learning model; and applying the optimized machine learning model to complete machine learning result evaluation and target area delineation. The present disclosure has the advantages of a small amount of required data, a quick operation speed, and a small and reliable delineation range of a target area.

### CROSS-REFERENCE TO RELATED APPLICATIONS

This application claims priority to Chinese Patent Application No. 202310271460.7 with a filing date of Mar. 16, 2023. The content of the aforementioned application, including any intervening amendments thereto, is incorporated herein by reference.

### TECHNICAL FIELD

The present disclosure relates to the field of mineral exploration, and in particular to a method for metallogenic prediction by using multi-source heterogeneous information.

### BACKGROUND

Delineation of a prospecting target area using traditional single exploration means has low reliability during mineral exploration in the western area of China, and unnecessary damage is caused to the ecological environment during engineering verification. The traditional single exploration means affected by natural geography, climate and traffic conditions, cannot satisfy the requirements on delineation of the prospecting target area in short term during brown land exploration and green land exploration by a western mining enterprise. Moreover, under the time background of big data in geological science, accumulated multi-disciplinary and multi-source heterogeneous data of different scales (for example, geological, geochemical and remote sensing) are in a state of decentralized and ineffective utilization. Accordingly, there is an urgent need in current field of prospecting on effectively integrate and mine geoscience multi-source data obtained based on expert experience from different areas in the past. It is also urgent to explore a method for quickly delineating a prospecting target area based on the geoscience multi-source data.

The method is guided by a specific deposit type of metallogenic system on the basis of a geographical information system as a platform, and extract and integrate multi-source geoscience data representing a dynamic mechanism, a material source, a migration channel, and mineralization emplacement of a metallogenic system. Therefore, it is quick to delineate a prospecting target area based on integration of geological, geochemical, and remote sensing data. For example, the prospecting target area is delineated through a spatial superposition integration technology in a geological data buffer zone (including metallogenic rock masses and lithological structural planes, specific directional faults and their intersections), a geochemical data buffer zone (including combined anomaly maps, comprehensive anomaly maps) and a remote sensing alteration information buffer zone (hydroxyl, Fe-oxide).

However, the traditional methods for delineating the prospecting target area still have the following defects by integrating geological, geochemical, and remote sensing data: (1) geochemical anomaly data are mostly a multi-element comprehensive anomaly map obtained through cluster analysis or factor analysis, and it fails to clearly indicate the specific type of deposit formed and the strength of mineralization; and (2) the spatial superposition technology has poor adaptability and prediction capability due to different distributions of multi-source heterogeneous data in different areas, resulting in a large delineation range of a target area and low accuracy. As a result, the current methods for quickly delineating the target area still have problems of unclear deposit type, poor adaptability of the spatial superposition integration technology, and low reliability and accuracy in delineation of the target area. It is urgent to develop a novel method for delineating a prospecting target area so as to further improve working efficiency and achieve prospecting breakthroughs.

### SUMMARY OF PRESENT INVENTION

The present disclosure provides a method for metallogenic prediction by using multi-source heterogeneous information to solve the technical problem of low accuracy existing in delineating a prospecting target area. The method includes the following steps:
S1, collecting, but is not limited to, geological, geochemical and remote sensing multi-source geoscience information data;
S2, building a conceptual model of a metallogenic system of special deposit style;
S3, extracting geoscience multi-source spatial proxy mineralization indication information according to the conceptual model of the metallogenic system;
S4, integrating and training data based on a neural network to obtain multi-dimensional spatial proxy layer data sets and training points;
S5, inputting the multi-dimensional spatial proxy layer data sets and the training points, and applying a machine learning algorithm for hyper-parameter optimization to obtain an optimized machine learning model;
S6, applying the optimized machine learning model to complete machine learning result evaluation and target area delineation.

In one embodiment, the geological, geochemical and remote sensing multi-source geoscience information data includes geological data of a working area, geochemical data of a primary halo or a secondary halo, multispectral or hyperspectral remote sensing image data, geophysical data, and genetic data of a known deposit.

In one embodiment, the conceptual model of the metallogenic system includes: a dynamic mechanism of a deposit of a working area, sources of a metallogenic geological body and a metallogenic material, ore-conducting and ore-bearing structures, mineralization and denudation preservation, and an alteration type and distribution range of a surface caused by hydrothermal solution.

In one embodiment, the extracting geoscience multi-source spatial proxy mineralization indication information specifically includes the following steps:
determining a grid size according to an area of a study area; extracting a spatial gridding evidence layer of a metallogenic related geological body, a combined anomaly map and a comprehensive anomaly map, and a distribution range of a hydroxyl-containing altered mineral combination according to a type of a target deposit; computing a geological connotation value of the evidence layer through an inverse distance weighted average interpolation method and re-classification; and determining an optimal buffer zone range of the evidence layer according to statistics of adjacent points.

In one embodiment, the data integration in step S4 specifically includes integration of multi-dimensional geological, geochemical and remote sensing mineralized spatial proxy indication information on the same grid by using the neural network to obtain different mineralization information spatial proxy data sets and training point files having geological connotation.

In one embodiment, the training points in the training point file include known deposit points and an equal number of non-deposit points randomly distributed in a blank area of the study area.

In one embodiment, the machine learning algorithm in step S5 includes: fuzzy clustering, a radial basis function neural network and a feasibility neural network.

In one embodiment, the hyper-parameter optimization specifically includes the steps of determining a number of radial basis functions and the number of times of iterations of machine learning in a hidden layer of the neural network, and determining accuracy of machine learning by means of parameters of a mean variance error (MSE) and the sum of squared errors (SSE) to obtain an optimal prediction result.

In one embodiment, the step S6 specifically includes: obtaining different exploration potential areas through a C-A fractal theory for prediction results of the optimized machine learning model.

The method has the advantages of a small amount of required data, a quick operation speed, and a small and reliable delineation range of the target area.

### BRIEF DESCRIPTION OF THE DRAWINGS

FIG. 1 is a flow chart showing a method according to the present disclosure;

FIG. 2 is a schematic diagram showing a data integration process of a neural network;

FIG. 3 is a schematic diagram showing a parameter optimization result;

FIG. 4 is a schematic diagram showing model result evaluation; and

FIG. 5 is a schematic diagram showing results obtained by utilizing C-A fractal.

### DETAILED DESCRIPTION OF THE EMBODIMENTS

In order to make the objective, technical solutions and advantages of the present disclosure clearer, implementation modes of the present disclosure will be further described in combination with the accompanying drawings below.

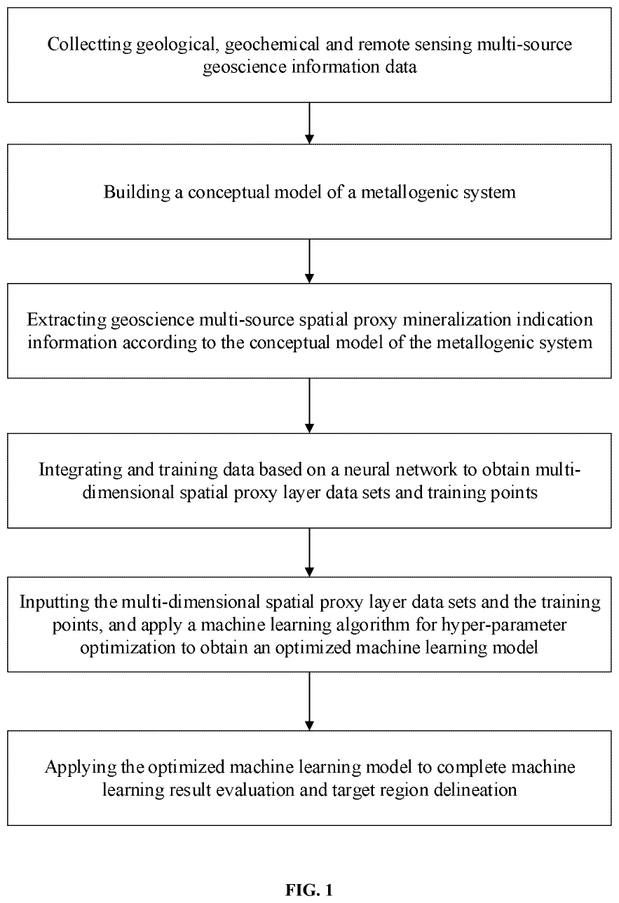

FIG. 1 is a flow chart of a method according to the present disclosure. The present disclosure provides a method for metallogenic prediction by using multi-source heterogeneous information. The method includes the following steps.

In step S1, the geological, geochemical and remote sensing multi-source geoscience information data is collected.

It should be noted that the present application collects geological data (a stratum, a structure and magmatite) of a working area, geochemical data of a primary halo or a secondary halo, multispectral or hyperspectral remote sensing image data, geophysical data, and genetic data of a known deposit style, which are not limitative.

In step S2, a conceptual model of a metallogenic system is built.

It should be noted that the conceptual model of the metallogenic system includes: dynamic mechanism of a deposit style of a working area, sources of metallogenic geological body and metallogenic material, ore-conducting and ore-bearing structures, mineralization and denudation preservation, and an alteration type and distribution range of a surface hydrothermal solution.

In step S3, geoscience multi-source spatial proxy mineralization indication information is extracted according to the conceptual model of the metallogenic system.

It should be noted that the step proxyS3 specifically includes the following steps:
determining a grid size according to an area of a study area; extracting a spatial gridding evidence layer of a metallogenic related geological body, a combined anomaly map and a comprehensive anomaly map, and a distribution range of a hydroxyl-containing altered mineral combination according to a type of target deposit; computing a geological connotation value of the evidence layer through an inverse distance weighted average interpolation method and re-classification; and determining an optimal buffer zone range of the evidence layer according to statistics of adjacent points.

A gridding size is determined by P=SN*0.0005, where P is the grid size, and SN is a scale of the study area.

In step S4, data is integrated and trained based on a neural network so as to obtain multi-dimensional spatial proxy layer data sets and training points.

The data integration in step S4 specifically includes integrating multi-dimensional geological, geochemical and remote sensing mineralized spatial proxy indication information on the same grid through the neural network, which obtain different mineralization information spatial proxy data sets and training point files having geological connotation.

The training points include known deposit points and an equal number of non-deposit points randomly distributed in a blank area of the study area.

In step S5, the multi-dimensional spatial proxy layer data sets and the training points are inputted, and a machine learning algorithm is applied for hyper-parameter optimization to obtain an optimized machine learning model.

It should be noted that the integrated data sets are imported into Explore software, and the machine learning algorithm is used for data parameter tuning and model result prediction.

The used machine learning algorithm includes: fuzzy clustering, a radial basis function neural network and a feasibility neural network. The data parameter tuning specifically includes the steps of determining a number of radial basis functions and the number of times of iterations of machine learning in a hidden layer of the neural network; and determining accuracy of machine learning by means of parameters of a mean variance error (MSE) and the sum of squared errors (SSE) on the basis of step S4 to obtain an optimal prediction result. Specifically, yᵢ is an i-th original value, ŷᵢ is an i-th predicted value, m is the number of hidden units, and wᵢ is a learned weight value.

$$MSE = \frac{1}{M} {\sum }_{i = 1}^{m} {( {y}_{i} - {\hat{y}}_{i} )}^{2}$$

$$SSE = \frac{1}{M} {\sum }_{i = 1}^{n} {( {y}_{i} - {\hat{y}}_{i} )}^{2}$$

In step S6, the optimized machine learning model is applied to complete machine learning result evaluation and target area delineation.

Different exploration potential areas are obtained by utilizing the C-A fractal theory for the prediction results of the machine learning model. It is indicated according to the C-A fractal results that a larger value represents a higher potential in finding the same deposit type, and a smaller value represents a lower potential in finding the same deposit type.

The machine learning result evaluation in step S6 includes receiver operator characteristic curve (ROC) model accuracy evaluation, prediction rate-area plotting (P-A plotting), and density standardization (Nd). An area below the ROC closer to 1 indicates a more accurate model prediction result. Reliability evaluation of a model prediction result of P-A plotting is as follows: a smaller percentage of an area occupied in the study area predicts more known deposits. Nd refers to a ratio of a prediction rate to an occupied area, and a value greater than 0.5 indicates that a model learning result has positive indication.

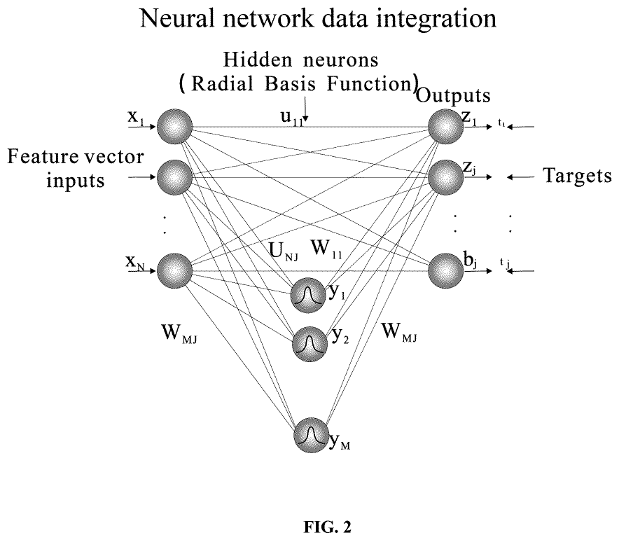

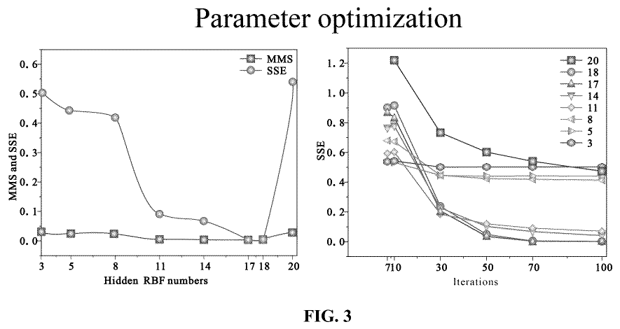

As an embodiment, in the present disclosure, multi-source geological data of 12 kinds of element geochemical data, such as Ag, Au, Bi, Cu, Hg, Mn, Mo, Pb, Sb, Sn, W and Zn from a Zhunuo ore-concentrated area (structure and miocene monzonitic granite porphyry) in a western Gangdise copper polymetallic metallogenic belt, and Aster remote sensing image data are collected and organized. According to expert experience, a porphyry copper deposit system model of the Zhunuo ore-concentrated area is established to further complete transformation, extraction, and integration of a spatial evidence layer (with reference to FIG. 2). Finally, a machine learning method is applied to optimize parameters, evaluate model results, and delineate a target area (with reference to FIGS. 3-5).

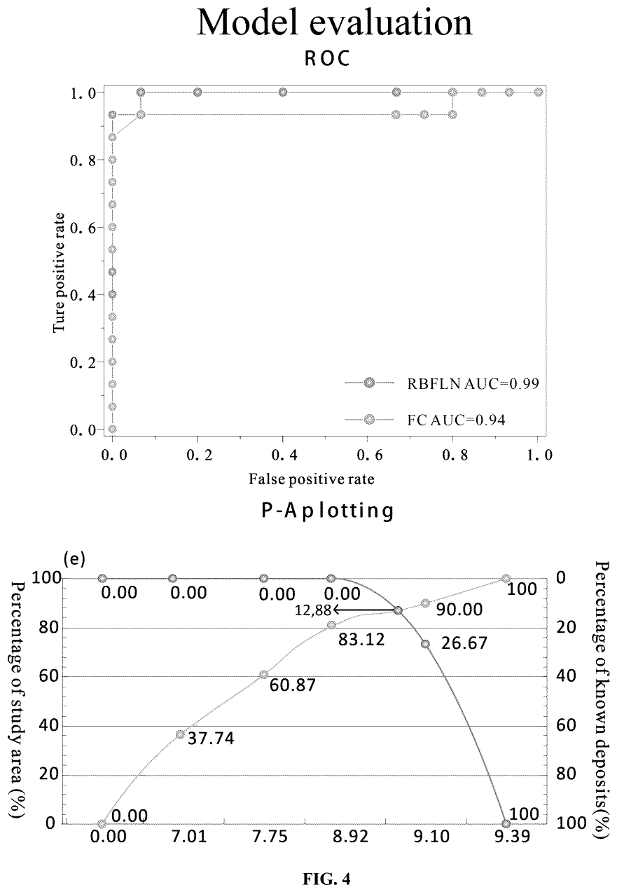

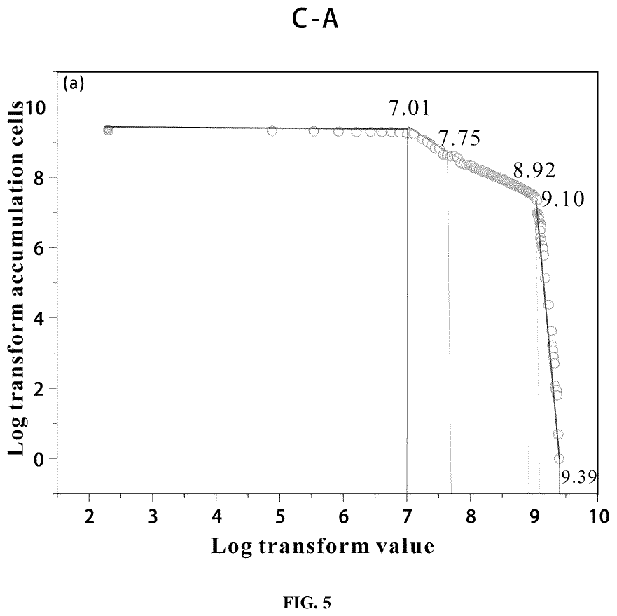

FIG. 2 shows a schematic diagram of a data integration process of a neural network. FIG. 3 is a schematic diagram of a parameter optimization result; FIG. 4 is a schematic diagram of evaluation of model results. FIG. 5 is a schematic diagram of results obtained by using C-A classification.

A plurality of prospecting target areas are delineated near 15 known mineralization points in the Zhunuo ore-concentrated area. The southwestern of the Zhunuo ore-concentrated area and the southwestern of Cimabanshuo have potential to search for porphyry copper. The southwest of Dongshibu and the northeast of Wubaduolai have potential to search for an epithermal deposit.

To sum up, the present disclosure have the beneficial effects:

(1) From the perspective of a deposit system, the expert experience is transformed into a spatial proxy of mineralization information, and a mixture model is used for driving to obtain an exploration potential prospect map.

(2) The method integrates multi-source geoscience information based on machine learning. It integrates a spatial proxy layer having objective geological connotation into a multi-dimensional data sets, and performs training according to positions of known deposit points and non-deposit points to obtain the prediction model data sets and the training points, rather than simply stacking data without a geological rule.

(3) The method is capable of capturing complex information between the known deposit points and mineralization information proxies based on the machine learning algorithm, and it hence has the advantages of a small amount of required data, a quick operation speed, and a small and reliable delineation range of a target area.

(4) The reliability and the accuracy of the predicted target area can be effectively evaluated by means of three indicators: receiver operator characteristic (ROC), P-A plotting, and Nd based on the results of the target area delineated by machine learning, thereby reducing uncertainty of the machine learning results.

What are described above are merely preferred embodiments of the present disclosure, and are not intended to limit the present disclosure. Any modification, equivalent replacement, improvement, etc. made within the spirit and principle of the present disclosure shall be encompassed in the scope of protection of the present disclosure.

What is claimed is:

1. A method for metallogenic prediction by using multi-source heterogeneous information, comprising the following steps:
S1, collecting geological, geochemical and remote sensing multi-source geoscience information data;
S2, building a conceptual model of a metallogenic system;
S3, extracting geoscience multi-source spatial proxy mineralization indication information according to the conceptual model of the metallogenic system;
S4, integrating and training data based on a neural network to obtain multi-dimensional spatial proxy layer data sets and training points;
S5, inputting the multi-dimensional spatial proxy layer data sets and the training points, and applying a machine learning algorithm for hyper-parameter optimization to obtain an optimized machine learning model;
S6, applying the optimized machine learning model to complete machine learning result evaluation and target area delineation.

2. The method according to claim 1, wherein the geological, geochemical and remote sensing multi-source geoscience information data comprises geological data of a working area, geochemical data of a primary halo or a secondary halo, multispectral or hyperspectral remote sensing image data, geophysical data, and genetic data of a known deposit.

3. The method according to claim 1, wherein the conceptual model of the metallogenic system comprises: a dynamic mechanism of a deposit of a working area, sources of a metallogenic geological body and a metallogenic material, ore-conducting and ore-bearing structures, mineralization and denudation preservation, and an alteration type and distribution range of a surface caused by hydrothermal solution.

4. The method according to claim 1, wherein the extracting geoscience multi-source spatial proxy mineralization indication information specifically comprises the following steps:
determining a grid size according to an area of a study area; extracting a spatial gridding evidence layer of a metallogenic related geological body, a combined anomaly map and a comprehensive anomaly map, and a distribution range of a hydroxyl-containing altered mineral combination according to a type of a target deposit; computing a geological connotation value of the evidence layer through an inverse distance weighted average interpolation method and re-classification; and determining an optimal buffer zone range of the evidence layer according to statistics of adjacent points.

5. The method according to claim 1, wherein the data integration in step S4 specifically comprises integration of multi-dimensional geological, geochemical and remote sensing mineralized spatial proxy indication information on the same grid through the neural network to obtain different mineralization information spatial proxy data sets and training point files having geological connotation.

6. The method according to claim 5, wherein the training points in a training point file comprise known deposit points and an equal number of non-deposit points randomly distributed in a blank area of the study area.

7. The method according to claim 1, wherein the machine learning algorithm in step S5 comprises: fuzzy clustering, a radial basis function neural network and a feasibility neural network.

8. The method according to claim 1, wherein the hyper-parameter optimization specifically comprises steps of determining a number of radial basis functions and the number of times of iterations of machine learning in a hidden layer of the neural network, and determining accuracy of machine learning by means of parameters of a mean variance error (MSE) and the sum of squared errors (SSE) to obtain an optimal prediction result.

9. The method according to claim 1, wherein step S6 specifically comprises: obtaining different exploration potential areas through a C-A fractal theory for prediction results of the optimized machine learning model.
